(19) United States
(12) Patent Application Publication
(10) Pub. No.: US 2024/0038080 A1
(43) Pub. Date: Feb. 1, 2024

(54) SYSTEM FOR BALANCING ENERGY SOURCE EXPLORATION AND OBSERVATION TIME OF AUTONOMOUS SENSING VEHICLES

(71) Applicant: TANDEMLAUNCH INC., Montreal (CA)

(72) Inventors: Farhad Rahbarnia, Monteal (CA); Alexandre Borowczyk, Montreal (CA); Jacob Willem Langelaan, University Park, PA (US)

(21) Appl. No.: 18/258,324

(22) PCT Filed: Dec. 22, 2021
(86) PCT No.: PCT/CA2021/051871

§ 371 Date: Jun. 19, 2023

Related U.S. Application Data
(60) Provisional application No. 63/130,308, filed on Dec. 23, 2020.

(51) Int. Cl. G08G 5/00; G05D 1/00; B64U 10/00; B64U 50/31

(52) U.S. Cl. CPC G08G 5/0069; G05D 1/0088; B64U 10/00; B64U 50/31; B64U 2201/10

(57) ABSTRACT

A multi-objective method of optimizing the time the ASV spends ‘in observation’ or ‘sensing’ and the time the ASV spends ‘recharging’ or ‘energy harvesting’ is taught herein. The method comprises: collecting data on observation points of interest, determining whether or not energy harvesting is needed, and effectively visiting the observation points of interest between the search for energy harvesting.

### TECHNICAL FIELD

The following relates to autonomous sensing vehicles and more specifically relates to energy harvesting methods of such autonomous sensing vehicles.

### BACKGROUND

Autonomous sensing vehicles (ASV) such as drones, unmanned aerial vehicles, controlled balloons (i.e. hot air balloons), remotely operated vehicles and remotely operated underwater vehicles are vehicles that are typically unoccupied, usually highly maneuverable, and can be operated remotely by a user proximate to the vehicle or can be operated autonomously. Autonomously operated vehicles do not require a user to operate them. Autonomous vehicles may have the potential to greatly improve both the range and endurance of unmanned vehicles. Autonomous sensing vehicles may be used for a number of uses including, but not limited to remote sensing, commercial surveillance, filmmaking, disaster relief, geological exploration, agriculture, rescue operations, and the like. It can be noted that it would be ideal to increase the operation time and endurance of ASV's for these and other uses. Autonomous sensing vehicles may contain a plethora of sensors which can include, but are not limited to accelerometers, altimeters, barometers, gyroscope, thermal cameras, cameras, LiDAR (Light Detection and Ranging) sensors, etc. These sensors may be useful for increasing the operation time and endurance of ASV or may be useful for the uses mentioned above. For instance, a gyroscope can be used for measuring or maintaining orientation and angular velocity of the ASV and may improve the operational time of the ASV; however, a camera may be used to take images during geological exploration.

One of the key constraints on the performance of the ASV can be energy. Energy can have a direct effect on the ASV's endurance, range, and its payload capacity. To manage the energy levels better, an ASV may extract energy from its environment, this is referred to as ‘energy harvesting’ herein. The ASV can use any method of energy harvesting, or a combination of energy harvesting methods to harvest energy to increase endurance and range of the ASV. In one example, underwater ASV's may harvest energy using wave currents. In another example, land ASV's may harvest energy level using solar power. In yet another example, aerial ASV's may harvest energy level using of thermal updrafts and ridge lifts (referred to as ‘soaring’ herein).

Soaring takes advantage of a thermals to increase the flight time of an aerial ASV and has been a studied and experimented in the past two decades. For example, in 2010, Edwards & Silverberg demonstrated soaring against human piloted competitors in the Montague Cross Country Challenge for remote-controlled sailplanes. However, there may be challenges related to soaring.

Some challenges include: sensing (an effective soaring system should be able to sense the surrounding environment and the motion of atmospheric currents); energy harvesting (the aerial ASV should be equipped to make decisions to exploit energy and avoid sinking in air), energy level considerations (i.e. the aerial ASV should be able to consider its energy state and that of the environment as it navigates).

AutoSoar (Depenbusch, Nathan T., John J. Bird, and Jack W. Langelaan. “The AutoSOAR autonomous soaring aircraft part 2: Hardware implementation and flight results.” Journal of Field Robotics 35.4 (2018): 435-458) addresses some of these issues. AutoSoar teaches a method of autonomous soaring using of thermal updrafts and ridge lifts. AutoSoar aims to address all the phases of thermal soaring such as: thermal detection, thermal latching and unlatching, thermal centering control, mapping, exploration, and flight management. AutoSoar aims to teach a method of increasing the flight time by using thermals and ease the search to find these thermals.

However, AutoSoar does not optimize the operational time of an ASV using energy harvesting while simultaneously achieving the ‘sensing’ or ‘observational’ goals of the ASV mission. There remains a need for a method which optimizes/balances the time the ASV spends ‘in observation’ or ‘sensing’ and the time the ASV spends ‘recharging’ or ‘energy harvesting’.

### SUMMARY

A multi-objective method of optimizing the time the ASV spends in ‘observation’ or ‘sensing’ and the time the ASV spends ‘recharging’ or ‘energy harvesting’ is taught herein. The method comprises: collecting data on observation points of interest, determining whether or not energy harvesting is needed, and effectively visiting the observation points of interest between the search for energy harvesting.

### BRIEF DESCRIPTION OF THE DRAWINGS

Embodiments will now be described with reference to the appended drawings wherein:

FIG. 1 is a schematic diagram of the off-board algorithm;

FIG. 2 is a schematic diagram of the on-board path planning system;

FIG. 3 is a schematic diagram of the time based algorithm;

FIG. 4 is a schematic diagram of a reward map;

FIG. 5 is a schematic diagram of a value function map;

FIG. 6 is a schematic diagram of a probability map of the previously-discovered thermals in a given region;

FIG. 7 is a schematic diagram of an embodiment of a combined map;

FIG. 8 is a schematic diagram of the decision-making AutoSoar system adjusted to include the greedy decision-making algorithm;

FIG. 9 is a is a schematic diagram of the on board system for the Smart Decision Making algorithm; and

FIG. 10 is a is a schematic diagram of the on-board system for the decision making algorithm having a reinforcement learning system.

### DETAILED DESCRIPTION

A multi-objective method of optimizing the time the ASV spends ‘in observation’ or ‘sensing’ and the time the ASV spends ‘recharging’ or ‘energy harvesting’ is taught herein. The method comprises: collecting data on observation points of interest, determining whether or not energy harvesting is needed, and effectively visiting the observation points of interest between the search for energy harvesting.

The method taught herein can increase the endurance of a ASV while effectively visiting the observation points of interest. The determination of the balance between energy harvesting, exploration for energy harvesting, and visit the observation points is taught herein. It can be noted that by using different input signals, the ASV is directed to expand its energy levels and operational times while following the observation targets.

An optimized system of ASV observation is taught herein. The system is comprised of an off-board computer software; and local on-board smart system. The off-board computer software program takes the past flight data, weather forecast, mission objectives, and ASV's characteristics. This program then uses this information, to generate a potential map of paths and potential paths. These maps and paths are planned with weather forecast aware system but do not need them to generate the maps.

The local on-board smart system takes the information from the off-board computer, signals from sensors, and autopilot command. It also may (or not) have access to a localized weather system (Third party). This system based can choose the next way point based on the information presented. It uses a Smart Decision Making System to balance between exploration and exploitation of the environment. This system will update the maps of energy sources. For example, this system may choose bank angel or speed of an aircraft to make it behave in a more optimized fashion. In an embodiment, the suggested solution allows an aerial ASV to take advantage of thermals while behaving as expected in the observation missions. In another embodiment, the suggested solution allows an underwater ASV to take advantage of wave currents while behaving as expected in the observation missions.

The local on-board smart system takes the information from the off-board computer, signals from sensors, and autopilot command. It also may (or may not) have access to a localized and global weather system from a third party. This system can choose the next way point based on the information presented. It uses a Smart Decision Making System to balance between exploration and exploitation of the environment. This system will update the maps of energy sources. This system may choose and/or modify the bank angel or speed of an aircraft to make it behave in a more optimized fashion. In an embodiment, the suggested solution allows an aerial ASV to take advantage of thermals while behaving as expected in the observation missions. In another embodiment, the suggested solution allows an underwater ASV to take advantage of wave currents while behaving as expected in the observation missions.

This method enables the endurance of the ASV to increase while the observation goals have been met. This method enables any ASV to effectively carry on their mission and take advantage of the free energy sources available in the atmosphere, (i.e. thermal updrafts, tidal energy, solar energy).

### Off-Board Path Planning and Map Generation

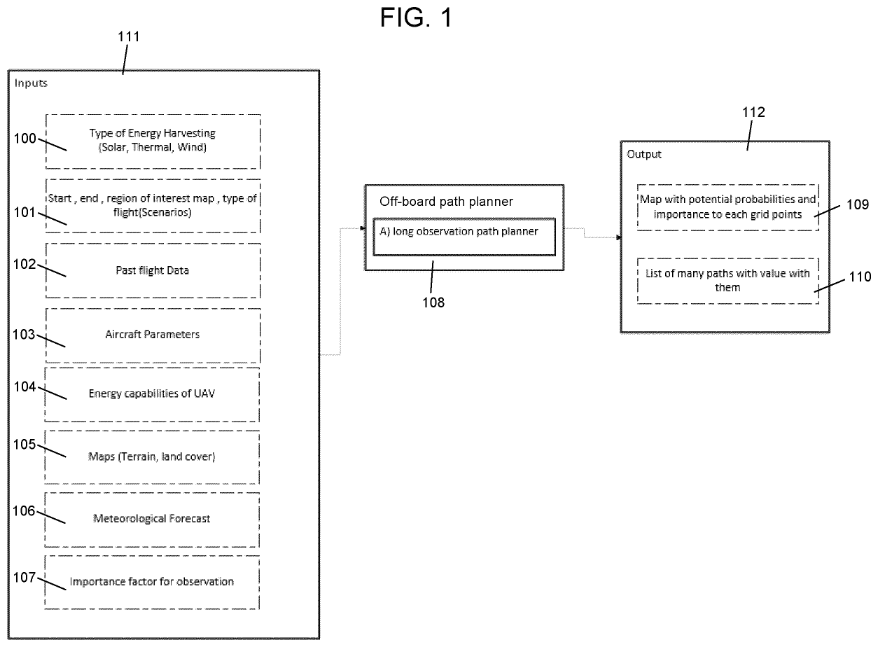

FIG. 1 shows a schematic diagram of the off-board algorithm. The off-board algorithm can calculate and generate desirable routes for the on-board computing agent. The off-board algorithm can create a poll of potential actions for the on-board computer to decide from. The off-board computer can take some inputs 111 and generate an output 112. Some outputs 112 include, but are not limited to: value function map 109 or a value list of many paths 110. Some inputs 111 include, but are not limited to: start point 101, end point 101, region(s) of interest 101, no-fly zones, boundaries, past flight data 102, aircraft parameters 103, energy capabilities of the ASV 104, maps (terrain, land cover, underwater, etc) 105, meteorological forecast 106; the importance factor for observation 107 and type(s) of energy harvesting required 100. The off-board algorithm, via the off board path planner 108, can take these inputs 111 and generate an output 112. In a preferred embodiment, the output 112 comprises the potential value function map 109 and/or the list of paths having a value associated with them 110.

Thus, in one embodiment, using dynamic programming and information available such as the location of observation points, past flight information 102, wind and weather forecast 106, and vehicle energy states 104, the off-board algorithm 108 generates a value function grid 109 of with values function associated with each grid. The system can use this as an input to the on-board computer system that manages the vehicle behavior during operation and determines when changing behavior is appropriate.

### On-Board Path Planning System

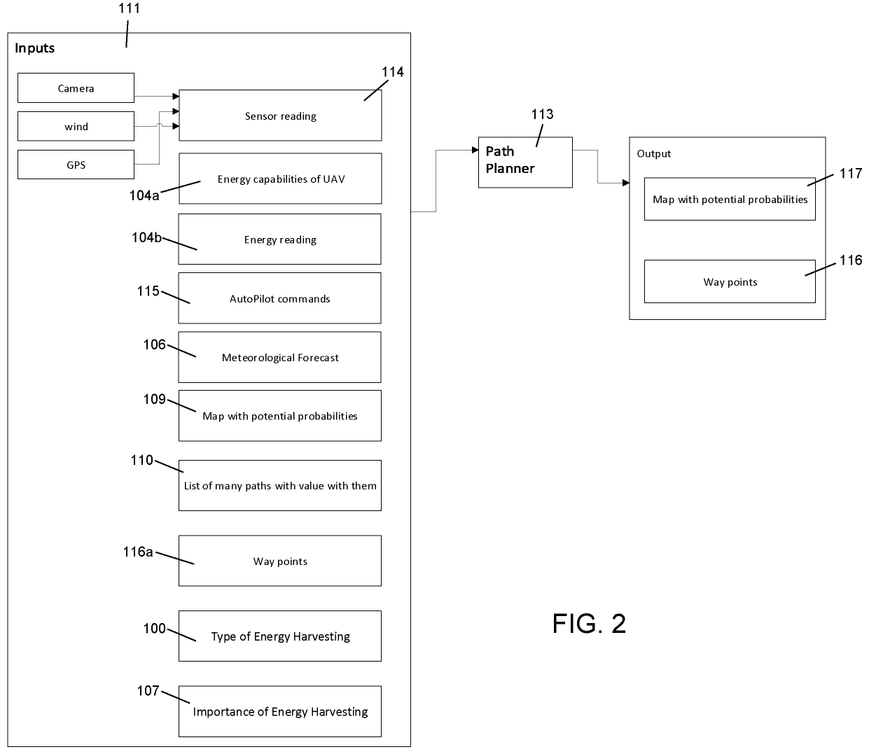

FIG. 2 shows a diagram of the on-board path planning system. Once the off-board global path planner 108 is computed, the on-board controller can use the output of the off-board system for its decision making. The on-board path planner 113 can: use the value function map 109 to generate potential behavior for the ASV considering the observation points (objectives) and fastest path to them; account for the sensor readings 114 (i.e. wind direction, energy levels, air restrictions, etc.); decision and balancing between exploration and exploitation of thermals and observation point exploring; optimize behavior near thermals and observation points (for instance: a thermal sequence or circling sequence around thermal uplift and observation point); generate a number of local way points, bank angle suggested speed of the ASV, etc.

Some inputs 111 of the on-board path planner 113 include, but are not limited to: sensor reading 114, energy capabilities of the ASV 104, energy reading 104b, autopilot commands 115, meteorological forecast 106, maps (terrain, land cover, underwater, etc) 105, the output 112 from the off-board planner 108, potential value function map 109, the list of paths having a value associated with them 110, waypoints 116a, type(s) of energy harvesting required 100, and the importance factor for observation 107. The inputs 111 to the on-board path planner 113 may also include end point 101, region(s) of interest 101, no-fly zones, boundaries, past flight data 102, and aircraft parameters 103. In a preferred embodiment, the output of the on-board (local) path planner 113 comprises a map with potential probabilities 117 and/or the list of new waypoints 116.

A variety of methods can be used in the local path planner 113. The methods include: the time-based algorithm; Greedy algorithm decision making; and Smart Decision Making System.

### Time Based Algorithm

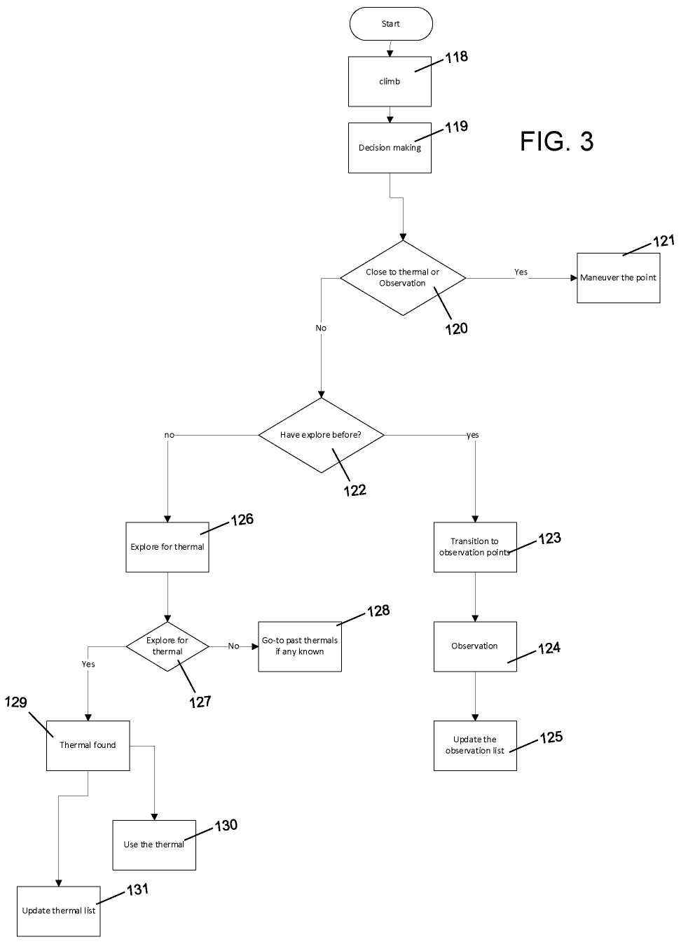

The time-based system can be used to balance the time spent on exploration for energy sources versus going on the mission. After defined time in energy source exploration mode, the system can directly begin observing the nearest mission. For example, an ASV using a time-based system could be on an observation mission for a specified amount of time. If after that time, the ASV is still in observation mode, the system can switch to energy-source exploration for another specified amount of time. The system can switch between exploration mode and observation mode multiple times. FIG. 3 shows the time based algorithm.

The ASV system can have access to a list of observation points. At a certain time, after completing exploration mode by climbing 118 and decision making 119, the ASV will look for a first observation point, (i.e. the closest observation point 120. The ASV can then decide to go to observe 124 the first observation point 123 and update the observation list 125; or, if the ASV has never explore the area for thermals 126 and use them to energy harvest 130 and update the list of thermals 131 as needed. In one embodiment, the balancing decision comes from a timer on board. If the timer times out during observation mode, the system will cause the ASV to switch to exploration mode 126 for a specified time. In one embodiment, the system can repeat this action till the ASV arrives at an observation point. Once the observation point is observed, the system will move that observation point to the end of the list of observation points and set the next observation point as the next goal. This sequence may be repeated. In another embodiment, if the timer times out during exploration mode, the system will cause the ASV to switch to observation mode for a specified time.

### Value Function Map

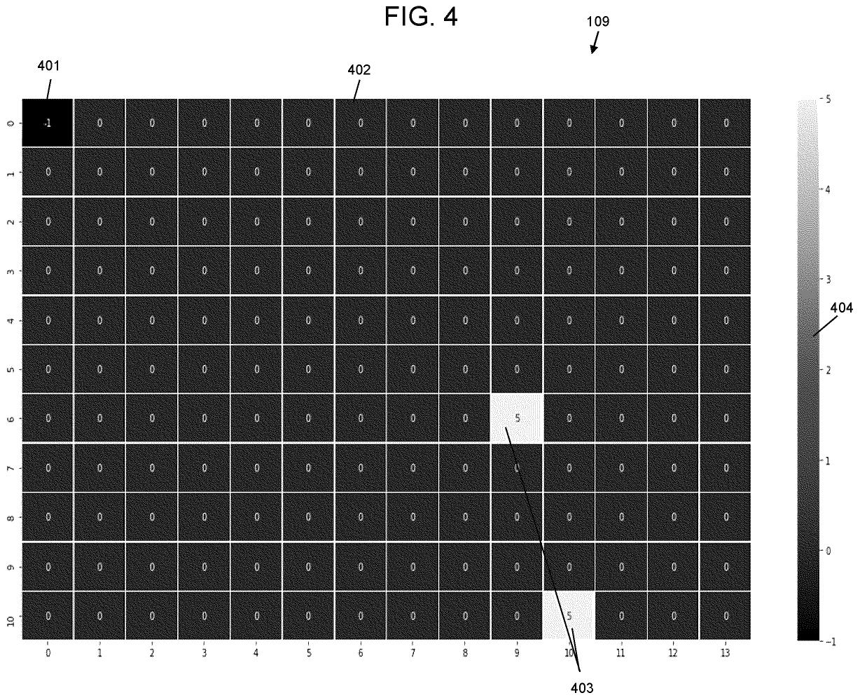

Since the location of the first observation point can be known, a grid map, or, value function map can be created that covers a whole region of interest. FIG. 4 shows an example of a potential value function map 109 created by the on-board or off-board path planner 108, 113. A user can input latitude, longitude and/or altitude information for an observation target. The system will then assign values to each target. In one embodiment, the reward map is created by assigning large positive rewards 403 to the point of interest, negative reward 401 to a “no fly” region (such as a region of bad weather). FIG. 4 shows an example of two points of observation 403 located at [6,9], and [10,10]; a starting point is located at [0,0]. Each point of observation is given a large positive value (5). In one embodiment, the starting point 401 is given a negative value of (−1). The remainder of the regions 402 are given a value of 0.

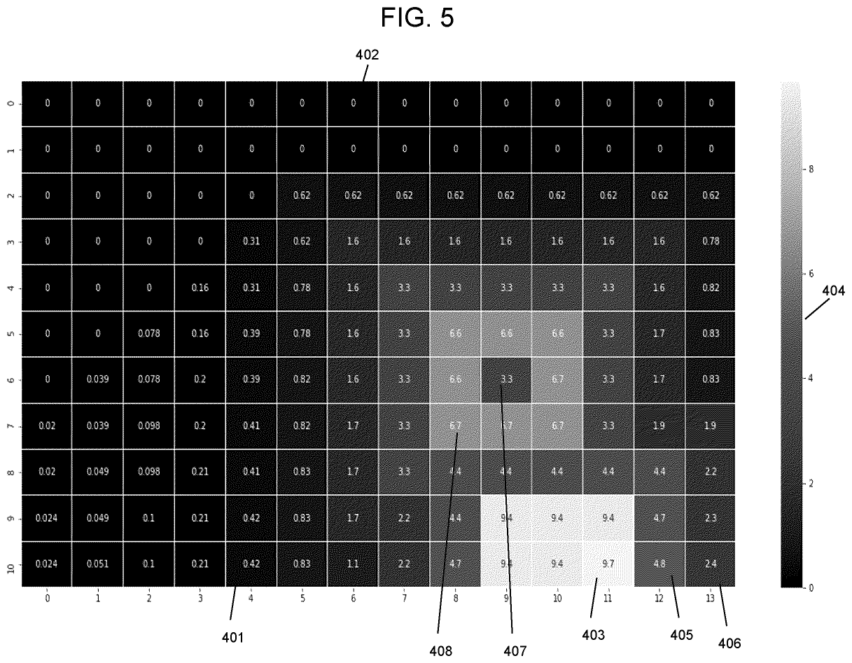

FIG. 5 shows another example of a value function map. The value function map is made using the reward map shown in FIG. 4 and a value function equation defined below. The system can calculate relative values corresponding to each cell/location. The method of generating the value function map can comprise: breaking the region of interest to a grid, adding a starting point, defining the potential observation points as a positive value cell. The method can further comprise the step of defining a grid state, i.e. define each cell as a new state for the environment. It is noted that the value 404 of each cell is correlated with how ‘good’ it is to be in that cell. One approach is to define a variable to tell us how good each cell is by assigning a reward to each cell. In one embodiment, this map is created by assigning large positive rewards to the point of interest, negative reward to a “no fly” region (such as a region of bad weather); and small positive reward to the past locations of thermal recurrences. A reward is added for going over the observation point. In FIG. 5, the highest value 403 is given to cell [11, 10]. Cells [12,10]; [8,7], etc are assigned a medium level of reward 408, 405. Cells [13, 10]; [9, 6] are assigned a low level of reward 406, 407. Cells [4, 10]; [6, 0] are assigned a neglible level of reward 401, 402.

The notion of “how good” 404 here is defined in terms of future rewards that can be expected, or in terms of expected return. Accordingly, value functions are defined with respect to policies. A policy is a mapping from each state, and action, to the probability of taking action when in the state.

The method can further comprise defining a set of possible actions. A special action set is defined by 8 moves possible by the ASV, with all action having the same probability to be chosen. The ASV can move 8 directions from any cell to its neighboring cells. It can be noted that edge cases are limited version of the actions (i.e. can only move 3 directions from [0,0]).

In order to define a value function equation, one can define a state s E S, where s can be a point in a grid size m×n, which represents a geological location. s can store values of weather, probability of energy, presence or absence of observation point. Let us define rewards as:

$${R}_{t} = \{ \begin{matrix}β & for states which have observations \\ θ & states that have energy gain potentials \\ 0 & otherwise\end{matrix}$$

where β and θ are real positive numbers. We then define action aₜ ∈Λ at grid t.

Note W.P symbolizes “with probability of”. We can then define policy Π(s, a) that assigns a value to probability of each actions at each states. For simplicity, we assume it is a uniform distribution policy from here on, but it may be anything or even be learnt.

$${a}_{t} = \{ \begin{matrix}MoveNorth & W . P p 1 \\ MoveSouth & W . P p 2 \\ MoveEast & W . P p 3 \\ MoveWest & W . P p 4 \\ MoveNorthEast & W . P p 5 \\ MoveNorthWest & W . P p 6 \\ MoveSouthEast & W . P p 7 \\ MoveSouthWest & W . P p 8\end{matrix}$$

Let us define Gₜ the expected reward at location t

$$\begin{matrix}{G}_{t} = [ {r}_{t} + γ {r}_{t + 1} + {γ}^{2} {r}_{t + 2} + … ] \\ ≡ {\sum }_{i = 0}^{∞} {γ}^{i} {r}_{t + i}\end{matrix}$$

here 0≤γ≤1 is the discount factor for future rewards
where rₜ, rₜ+1, . . . are generated by following policy π starting at state s

The Value function of each grid points can then be:

$$\begin{matrix}{V}^{π} ( s ) = E [ {G}_{t} \vert {S}_{t} = s ] \\ ≡ E [ {\sum }_{i = 0}^{∞} {γ}^{i} {r}_{t + i} \vert {S}_{t} = s ]\end{matrix}$$

where rₜ, rₜ+1, . . . are generated by following policy π starting at state s

We use the Value function to generate the maps of value function grids.

The above-noted steps can also be applied for multiple sources of input, (i.e. with past flight information or wind). In one embodiment, one of the multiple sources of input may include past flight information.

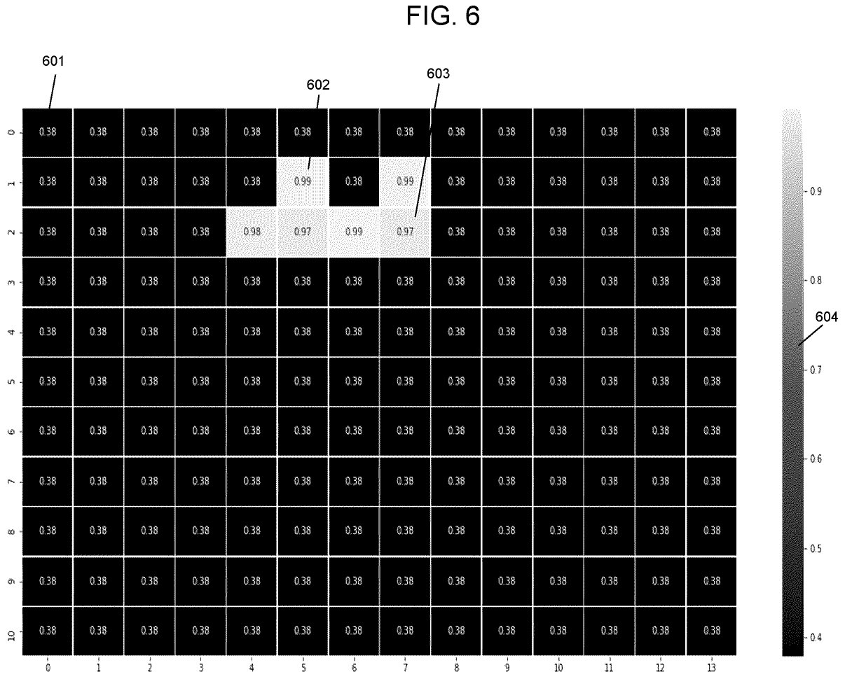

FIG. 6 shows a probability map of the previously-discovered thermals in a given region. The closer the cell value is to one, the more likely that a thermal was previously encountered at that location. The probability map can show the likelihood of finding an energy source from past flight/weather information. For example, there is a 99% likelihood of finding energy source at [5,1] 602; a 97% likelihood of finding energy source at [7,2] 603; and a 38% likelihood of finding energy source on the black squares 601 labelled 0.38.

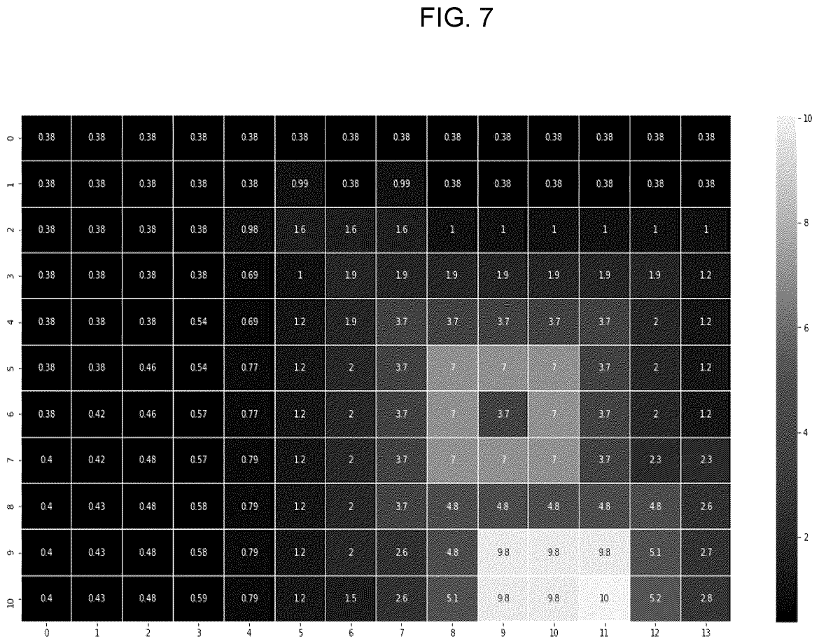

FIG. 7 shows an embodiment of combined map. The combined map can combine the value function map with the probability map. The combined map can be a dynamic map, that changes based on user inputs of alpha. The greedy decision making algorithm below explains the user-defined alpha value in more detail. The values of each cell are weighted differently based on a user-defined alpha value. For example, if the user-defined alpha value is closer to observation mode, the observation points will have higher relative weighting. This will allow the system to more likely default to observation mode. In another instance, if the user defines the alpha value as closer to exploration for energy harvesting, the energy sources will have higher relative weighting. This will allow the system to more likely default to exploration mode.

It is important to note that there are many ways of combining the value function map and the probability map information, such as adding a high reward value to the regions of high probability of thermals and low value otherwise. In one embodiment, an importance multiplier can be introduced that balance the rewards associated with observation points and thermal updraft points. The importance multiplier value can be tuned based on different mission where sometimes the exploration of thermal is more important the observing the observation point and vice versa.

The observation points may also be moving. The algorithm can follow any observation point that can be fixed or moving. Moving targets may require an online connection to refresh the map.

### Greedy Decision Making Algorithm

The greedy decision making algorithm can balance between the exploration for energy sources and observation mode by a greedy probability.

Once a value function map is defined, the map for the optimal behavior can be defined as follows. Define steps or, actions that the ASV takes to travel 1 or n number of cells. The value function map shows the optimal behavior as the action that can be taken by the ASV from each given cell to the highest value neighboring cell.

The greedy decision making algorithm can then balancing between observation mode and exploration mode. The algorithm can utilize various maps to decide the behavior of the ASV such as exploration and observation modes. In one embodiment, the system will choose to visit the highest value neighboring cell as this is the cell that defines a path for optimal behavior. In another embodiment, to achieve more accurate decision making and behavior, a biasing map may be used in combination with the value function map. The biasing map can choose the best valued cell given matching the biasing direction. The algorithm can narrow down the potential cells to choose from by utilizing the biasing map.

The greedy decision making algorithm can then start exploration mode to find new energy sources. In one embodiment, the algorithm can include the biasing map in combination with the exploration map and bias the map toward the observation point.

In another embodiment, the algorithm can switch between exploration mode and observation mode with a greedy or a stochastic function. An a value can be defined. The alpha value can represent the balance between exploration and going to observation point. The alpha value changes between 0 to 1. In one embodiment, the alpha value can be defined such that the closer it is to zero, it favors exploration mode; and the closer it is to 1, it favors observation mode. As time goes on and more exploration is conducted, the alpha-value increases toward one. This enforces that the observation point is met. Once the ASV arrives at the observation point, the alpha value goes close to 0 (such as 0.0001). This allows the ASV to go back to exploration. Over time, the ASV comes back to exploration mode as the speed of the alpha value is decaying. The increasing of the alpha value depends on a hyper parameter. The hyper parameter can be chosen by the user. It can range between 1% and 99%. The preferable range is approximately 5-15%. For instance, a 10% hyper parameter updates the map each time an observation point is visited. The reward for that observation point is lowered close to 0 so that it favors another observation point over the current observation point. This action may be repeated till all the observation points have been observed. In another instance, once the next observation point is achieved, the value of reward can be restored for the earlier observation point.

The greedy decision-making algorithm is beneficial as many observation points may be defined. It can be generalized with different observation points having different importance levels. It can include priority and wind map information to generate the value function easily and make the map smarter. Furthermore, can be adopted to be run on the ASV and provide live updates.

The following step function may be used:

$$f ( x ) = \{ \begin{matrix}Explore , & w . p ( 1 - α ) \\ Go - to\_obsr , & w . p α\end{matrix}$$

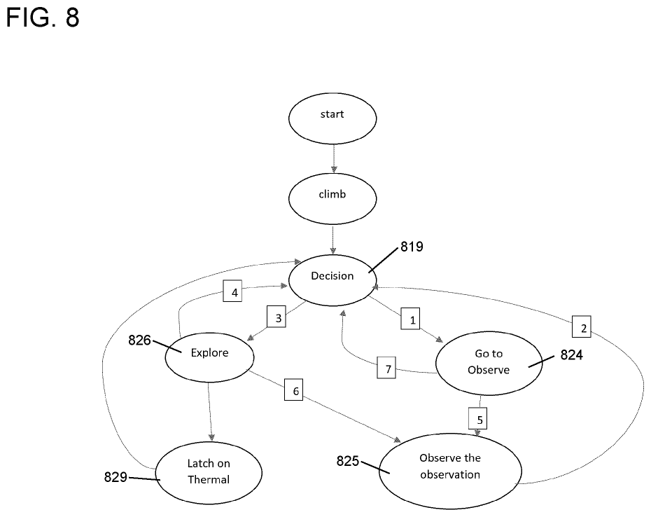

FIG. 8 provides a state diagram of the decision-making 819 AutoSoar system adjusted to include the greedy decision-making algorithm. The “go to observe” tab 824 is just directed move to observation mode 825. The amount of time spent in exploration mode 826 may be adjusted or chosen by the user. The amount of time spent in observation mode 825 may be adjusted or chosen by the user.
1. With probability of a we go to the go-to-observe state 824.
2. Once we finish with observation points 825, we go from the observation state to decisions state 819 and set the α=0.001.
3. With probability of 1−α we go to the Explore state 826.
4. One side explore state we do 1 Exploration As defined by AutoSoar exploration methods. We increase α=α+0.1 as we go back to the decision state 819.
5. If we are in a close approximate the observation point, we will go to that observation 825 as tagged in the diagram by 5 and 6
6. We only move 1 cell and then go back to the decision-making state 819.
7. If we encounter the thermal, then latch on it 829.
8. Once we finish latching 829 on and we go back to the decision-making 819.

### Smart Decision Making System

The Smart Decision Making System is a combination of the earlier methods. In this algorithm, the actions of the system are biased by set of rules defined before the flight. A bias algorithm can be used to choose the best action that maximize the chances of thermal and maximize the observation behavior. The actions of the system may be biased by a set of rules defined before the flight.

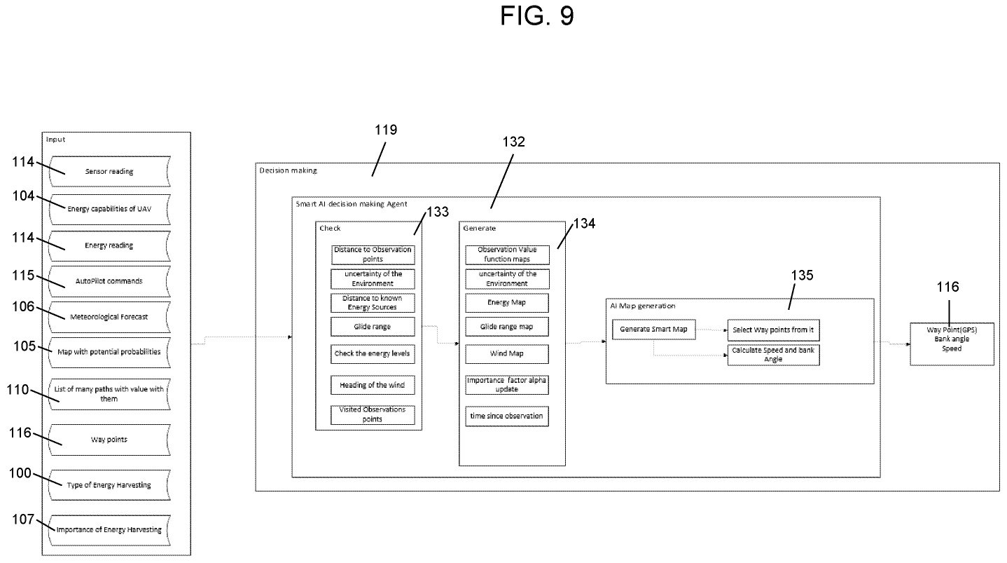

FIG. 9 is a is a schematic diagram of the on board system for the Smart Decision Making algorithm 119. The algorithm combines the time algorithm, the greedy algorithm, and sensor reading to explore the environment for more desirable energy sources. The actions are optimized based such that it maximizes the behavior the system towards the observation points and past known energy sources. It uses the biases defined in the earlier optimization to maximize the exploitation in a safe manner and efficiently.

The algorithm can evaluate the readings of the sensors 114 and evaluate its value function map. In one embodiment, the algorithm can be configured to trigger a new global path planner sequence if it believes the original maps are not accurate enough.

Smart AI decision making system is an on-line decision making. It can be placed on board or off board. The algorithm uses the input signals to decide on next way points, bank angle and the speed of ASV. The AI system 132 first checks 133 the readings from inputs, if they are any uncertainty or the readings are different from its value function, it will recalculate 134 and update its value function of environment.

If the readings are in the acceptable range of the value function of the system, the system will generate an observation map (such as a value function map), uncertainty map, energy, wind, and glide map. The AI system 132 then uses the alpha factor that is defined before the flight to combine these maps.

The observation map can also be modified by a time factor. Time Factor is a value between 0 to 1. It modifies the rewards of observation points before updating value function map. If an observation point is observed the reward of it goes down.

Since we combine the maps, the generated map 135 is biased towards energy sources, observation points, wind directions, and heading of the ASV.

The Smart AI decision making system 132 then calculates the trajectory and direction for next point to travel to, generates a waypoint 116, bank angle, and speed.

Reinforcement learning (RL) agent Decision Making System

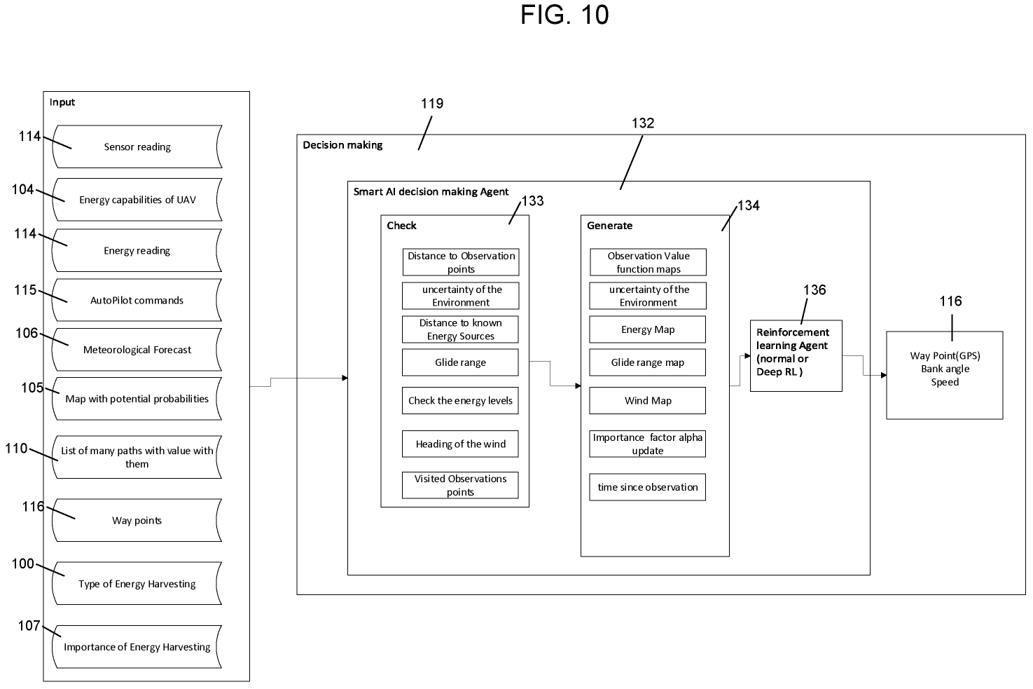

The RL system 136 is similar to the Smart Decision-Making System. FIG. 10 is a is a schematic diagram of the on-board system for the decision making algorithm having a reinforcement learning system 136. In this embodiment, the system uses the information to decide to either visit the point of observation or to visit the point of energy harvesting based on the decision.

The RL system 136 can be trained or engineered to make the decision. One method of the training is to let the RL agent to be trained in the simulation environment. The evaluation can be by human feedback or compare the results with other systems results.

A reward function can be defined to also train the RL agent that evaluate how much energy was used, whether observation points were visited, and time spent on them. The RL system can use a deep Neural Network as well. The RL system makes the decision based on the input signals and the processed data, the next few points.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1-6. (canceled)

7. A method for controlling an autonomous sensing vehicle (ASV) comprising:
preparing a reward mapping, where the reward map is a map of the area of interest divided into a geographical grid of grid points;
for each grid point storing information about whether the grid point is an observation point, a probability of finding energy, the expected energy amount, and an indication of the reliability of the probability of finding energy;
and for each grid point calculating a reward r based on whether the grid point is an observation point, and a probability of finding energy, the expected energy amount, and an indication of the reliability of the probability of finding energy;
calculating for each grid point a discounted probabilistic reward G is calculated using a weighted combination of the present and future rewards at that point and calculated as below:
$$\begin{matrix}{G}_{t} = [ {r}_{t} + γ {r}_{t + 1} + {γ}^{2} {r}_{t + 2} + … ] \\ ≡ {\sum }_{i = 0}^{∞} {γ}^{i} {r}_{t + i}\end{matrix}$$
where t indicates the present time, rₜ is the reward at time t and γ is a value between 0 and 1 and is the discount value for future reward, and rₜ is a distribution of rewards for moves in a particular direction based on the probability of finding energy, the expected energy amount, and an indication of the reliability of the probability of finding energy, and the value of making an observation;
calculating at each grid point an expected value V of the discounted probabilistic reward G at that grid point; and
directing the ASV to the adjacent grid point with the highest expected value V;
and further comprising a variable between 0 and 1 indicating the priority of seeking energy, where 1 indicates that the reward r is entirely based on finding energy and 0 indicates that the reward r is entirely based on making an observation, and increasing the variable as the useful energy of the ASV decreases, and using this variable to either:
(a) adjust the calculation of the reward r; or
(b) modify the calculation of the expected value V.

8. The method of claim 7, where the formula reflecting whether the grid point is a potential source of energy or an observation point is: β when the grid point is a grid point where the ASV can make an observation, θ when the grid point is a potential source of energy, and zero in all other cases, and the values of β and θ are set by a predetermined formula.

9. The method of claim 7, where the value of γ is 0.

10. The method of claim 7, where the step of modifying the expected value V for each grid point further comprises incorporating biasing.

11. The method of claim 7, where the step of modifying the expected value V for each grid point comprises alternating between periods of time where the expected value V only reflects energy sources and period of time where the expected value V only reflects observations.

12. The method of claim 7, further comprising updating the stored information about whether a grid point is an observation point, the probability of finding energy, the expected energy amount, and an indication of the reliability of the probability of finding energy of the map of energy sources.

13. The method of claim 7, further comprising updating the stored information about whether a grid point is an observation point, the probability of finding energy, the expected energy amount, and an indication of the reliability of the probability of finding energy of the map of energy sources, using sensor information from at least one sensor on the ASV.

14. The method of claim 13, where the sensor information comprises one of more of the following: the airspeed of the ASV, the heading of the ASV, the geographical location of the ASV, the inertial measurements of the ASV, the ambient temperature, ambient pressure, ambient humidity.

15. The method of claim 7, where r is further determined by one of more of the following inputs: the type of energy harvesting, the purpose of the flight, data from past flights, identification of no-fly zones, the aircraft parameters, the energy capabilities of the UAV, meteorological forecast, and importance factors for the observations; meteorological forecast, maps, waypoints that the ASV must cross, and the importance factor for observation.

16. A method for controlling an autonomous sensing vehicle (ASV) comprising:
preparing a map of energy sources, where the map of energy sources is a map of the area of interest divided into a geographical grid, and where at least two or more points on the grid are associated with a probability of finding energy, the expected energy amount, and an indication of the reliability of the probability of finding energy;
preparing a value function map, where the value function map is a map of the area of interest divided into the same geographical grid as the map of energy sources and at least one point on the grid is associated with a reward r, where r is determined by a formula reflecting whether the grid point is a potential source of energy or an observation point;
preparing a reward map, where the reward map is a map of the area of interest divided into the same geographical grid as the map of energy sources and the discounted probabilistic reward G of each grid point is calculated using a weighted combination of the present and future rewards at that point and calculated as below:
$$\begin{matrix}{G}_{t} = [ {r}_{t} + γ {r}_{t + 1} + {γ}^{2} {r}_{t + 2} + … ] \\ ≡ {\sum }_{i = 0}^{∞} {γ}^{i} {r}_{t + i}\end{matrix}$$
where t indicates the present time, rₜ is the reward at time t and γ is a value between 0 and 1 and is the discount value for future reward, and rₜ is a distribution of rewards for moves in a particular direction based on the probability of finding energy, the expected energy amount, and an indication of the reliability of the probability of finding energy, and the value of making an observation;
preparing a value map, where the value map is a map of the area of interest divided into the same geographical grid as the map of energy sources, and the expected value V of each grid point is the expected value of the discounted probabilistic reward G of each grid point;
preparing a combined value map, where the combined value map is a map of the area of interest divided into the same geographical grid as the map of energy sources where expected value V for each grid point is modified to reflect the priority of seeking energy; and
directing the ASV to the adjacent grid point with the highest combined value from the combined value map.

17. The method of claim 16, where the formula reflecting whether the grid point is a potential source of energy or an observation point is: β when the grid point is a grid point where the ASV can make an observation, θ when the grid point is a potential source of energy, and zero in all other cases, and the values of β and θ are set by a predetermined formula.

18. The method of claim 16, where modifying the expected value V comprises increasing the weighting of energy sources versus the weighting of making an observation in the reward r by a variable between 0 and 1, where 1 indicates that the reward r is entirely based on finding energy and 0 indicates that the reward r is entirely based on making an observation, and increasing the variable as the useful energy of the ASV decreases.

19. The method of claim 16, where the value of γ is 0.

20. The method of claim 16, where the step of modifying the expected value V for each grid point further comprises incorporating biasing.

21. The method of claim 16, where the step of modifying the expected value V for each grid point comprises alternating between periods of time where the expected value V only reflects energy sources and period of time where the expected value V only reflects observations.

22. The method of claim 16, further comprising updating one of the map of energy sources, the value function map, the reward map or the value map using sensor information from at least one sensor on the ASV.

23. The method of claim 22, where the sensor information comprises one of more of the following: the airspeed of the ASV, the heading of the ASV, the geographical location of the ASV, the inertial measurements of the ASV, the ambient temperature, ambient pressure, ambient humidity.

24. The method of claim 16, where r is further determined by one of more of the following inputs: the type of energy harvesting, the purpose of the flight, data from past flights, identification of no-fly zones, the aircraft parameters, the energy capabilities of the UAV, meteorological forecast, and importance factors for the observations; meteorological forecast, maps, waypoints that the ASV must cross, and the importance factor for observation.

25. A system for controlling an autonomous sensing vehicle (ASV) comprising:
a computing system comprising an on-board system that is local to the ASV;
the computing system configured to store, for each grid point representing a point on a map of the area of interest divided into a geographical grid, information about whether the grid point is an observation point, a probability of finding energy, the expected energy amount, and an indication of the reliability of the probability of finding energy;
the computing system configured to calculate, for each grid point, a reward r based on whether the grid point is an observation point, and a probability of finding energy, the expected energy amount, and an indication of the reliability of the probability of finding energy;
the computing system configured to calculate for each grid point a discounted probabilistic reward G is calculated using a weighted combination of the present and future rewards at that point and calculated as below:
$$\begin{matrix}{G}_{t} = [ {r}_{t} + γ {r}_{t + 1} + {γ}^{2} {r}_{t + 2} + … ] \\ ≡ {\sum }_{i = 0}^{∞} {γ}^{i} {r}_{t + i}\end{matrix}$$
where t indicates the present time, rₜ is the reward at time t and γ is a value between 0 and 1 and is the discount value for future reward, and rₜ is a distribution of rewards for moves in a particular direction based on probability of finding energy, the expected energy amount, and an indication of the reliability of the probability of finding energy, and the value of making an observation;
the computing system configured to calculate for each grid point an expected value V of the discounted probabilistic reward G at that grid point;
the computing system configured to modify the expected value V at each grid point to reflect the priority of seeking energy; and
the computing system configured to direct the ASV to the adjacent grid point with the highest modified expected value V.

26. The system of claim 25 where the computing system further comprises an off-board computing system.
